(19) United States
(12) Patent Application Publication
(10) Pub. No.: US 2015/0105203 A1
(43) Pub. Date: Apr. 16, 2015

(54) POWER TRANSMISSION APPARATUS FOR VEHICLE

(71) Applicant: Hyundai Motor Company, Seoul (KR)

(72) Inventor: Wan Soo KIM, Hwaseong-si (KR)

(73) Assignee: Hyundai Motor Company, Seoul (KR)

(21) Appl. No.: 14/140,417

(22) Filed: Dec. 24, 2013

(30) Foreign Application Priority Data
Oct. 14, 2013 (KR) 10-2013-0122230

(51) Int. Cl. B60K 6/54

(52) U.S. Cl. CPC B60K 6/54; Y10S 903/902
USPC 475/5; 180/65.21; 903/902

(57) ABSTRACT

A power transmission apparatus for a vehicle includes a first clutch and a second clutch, a first input shaft selectively connected with an engine through the first clutch and a second input shaft selectively connected with the engine through the second clutch, an electric supplement drive unit that is a motor generator performing functions of both of a motor and a generator and transmits a driving force to the second rotary shaft, a planetary gear set including first, second, and third rotating elements, in which the first rotating element is connected with the electric supplement drive unit through the second rotary shaft, the second rotating element is selectively connected with the engine through the first rotary shaft, and the third rotating element functions as a fixing element, and a shifting unit that shifts and outputs torque of the first input shaft of the input unit at several stages.

### CROSS-REFERENCE TO RELATED APPLICATION

The present application claims priority to Korean Patent Application No. 10-2013-0122230 filed on Oct. 14, 2013, the entire contents of which is incorporated herein for all purposes by this reference.

### BACKGROUND OF THE INVENTION

1. Field of the Invention

The present invention relates to a power transmission apparatus for a vehicle which can achieve smooth start and shift and improve fuel efficiency and acceleration performance by adding an electric supplementary drive unit and a torque converting unit to a double clutch transmission.

2. Description of Related Art

For vehicles, the environmentally-friendly technology is a critical technology determining the fate of the future vehicle industry and the automobile manufacturers have devoted all their strength to develop environmentally-friendly vehicles for satisfying the rules of environment and fuel efficiency.

The future vehicle technology may be classified, for example, into an electric vehicle (EV) using electric energy, a hybrid electric vehicle (HEV), and a double clutch transmission (DCT) that has improved efficiency and convenience.

Further, the automobile manufacturers make efforts to put an ISG (Idle Stop and Go) system and regenerative braking system to practical use for satisfying regulations of exhaust gas of many countries and improving efficiency of the power transmission system to improve fuel efficiency.

The ISG is a technology of stopping an engine when a vehicle stops, and starting the engine, when the vehicle starts, and the regenerative braking is a technology that drives a generator, using kinetic energy of a vehicle, in braking a vehicle, instead of braking a vehicle with friction in the related art, stores electric energy generated in this process in a battery, and then uses the electric energy, when driving the vehicle.

Hybrid electric vehicles for which the power transmission apparatus of the present invention is useful are vehicles using two or more energy sources (power sources) and may be implemented in various types, in which, generally, a gasoline engine or a diesel engine of the related art which uses fossil fuel and a motor/generator driven by electric energy are combined.

As a transmission that can be used for the hybrid electric vehicles, a DCT may be an example and the DCT can increase efficiency and improve convenience by using two clutches in the structure of a manual transmission.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a power transmission apparatus for a vehicle having advantages of being able to achieve smooth start and shift and improve fuel efficiency and acceleration performance by adding an electric supplementary drive unit and a torque converting unit in a double clutch transmission.

An exemplary embodiment of the present invention provides a power transmission apparatus for a vehicle, which may include a power connecting unit composed of a first clutch and a second clutch, an input unit composed of a first input shaft selectively connected with an engine through the first clutch and a second input shaft disposed coaxially with the first input shaft and selectively connected with the engine through the second clutch, an electric supplement drive unit that is a motor generator performing functions of both of a motor and a generator and transmits a driving force to the second rotary shaft, a torque converting unit that is a planetary gear set including first, second, and third rotating elements, in which the first rotating element is connected with the electric supplement drive unit through the second rotary shaft, the second rotating element is selectively connected with the engine through the first rotary shaft, and the third rotating element functions as a fixing element, and a shifting unit that shifts and outputs torque of the first input shaft of the input unit at several stages.

In the input unit, the second input shaft may be a hollow shaft and the first input shaft may be coaxially disposed through the hole in the second input shaft.

The electric supplement drive unit may be composed of a rotor connected with the second rotary shaft and a stator disposed around the rotor and fixed to a housing.

The torque converting unit may be a single pinion planetary gear set including a first rotating element that is a sun gear, a second rotating element that is a planetary carrier, and a third rotating element that is a ring gear.

The torque converting unit may be a double pinion planetary gear set including a first rotating element that is a sun gear, a second rotating element that is a ring gear, and a third rotating element that is a planetary carrier.

The shifting unit may include first and second input gears disposed on the first input shaft, first and second output shafts disposed in parallel with the first input shaft, and a plurality of output gears disposed on the first and second output shafts in mesh with the first or second input gear on the first input shaft and selectively synchronized with the first output shaft or the second output shaft by corresponding synchronizing units.

According to an exemplary embodiment of the present invention of the present invention, starting and shifting is made by the motor/generator that is an electric supplement drive unit and the planetary gear set that is a torque converting unit, such that smooth starting and shifting can be achieved.

Further, it is possible to improve the problem of non-load gear noise and a loss of drag of idle gears which are generated due to the structure in the existing manual transmissions.

Further, the planetary gear set that is used as a torque converting unit distributes input torque in comparison to an external gear, such that power transmission efficiency and durability is high and the rigidity is high, and thus it is advantageous in gear whine noise.

Further, when auxiliary power is inputted by the motor/generator, the power is transmitted with torque increased through the planetary gear set and the rotation speed is larger than the engine, such that it can be used in a high speed region with a high efficiency point.

Further, it is possible to start the engine with the motor/generator without a specific start motor and it is possible to shift to the fourth stage in the EV mode, such that it is possible to decrease use at the efficiency point and the capacity of the motor/generator.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view of a power transmission apparatus for a vehicle according to a various exemplary embodiments of the present invention.

FIG. 2 is table showing operation factors of the power transmission apparatus for a vehicle according to the various exemplary embodiments of the present invention.

FIG. 3 is a schematic view of a power transmission apparatus for a vehicle according to a various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

The parts that are not related to the description of the exemplary embodiments are not shown to make the description clear and like reference numerals designate like element throughout the specification.

Using the terms of the first and the second etc. is for discriminating the components having the same name and they are not limited to the order.

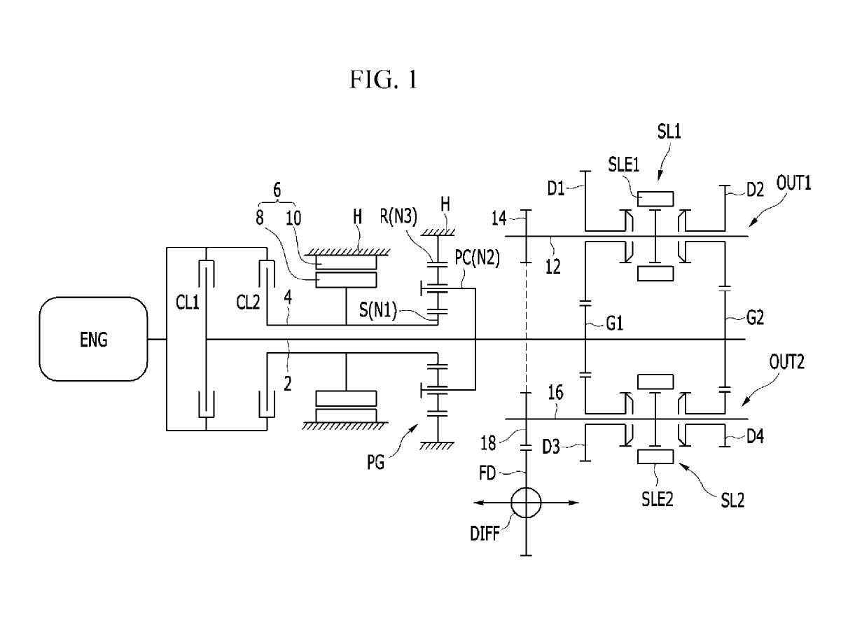

FIG. 1 is a schematic view of a power transmission apparatus for a vehicle according to a first exemplary embodiment of the present invention.

Referring to FIG. 1, a power transmission apparatus according to the first exemplary embodiment of the present invention includes a power connecting unit, an input unit, an electric supplementary drive unit, a torque converting unit, and a shifting unit.

The power connecting unit includes a first clutch CL1 and a second clutch CL2, the first clutch CL1 and the second clutch CL2 are fluid multi-plate clutches and may be controlled to operate and stop by a hydraulic control system, or it may be dry multi-plate clutches.

The input unit may include a first input shaft 2 and a second input shaft 4.

The first input shaft 2 is a solid shaft and the second input shaft 4 is a hollow shaft.

The first input shaft 2 is disposed through the space in the second input shaft 4 without interference and connected to an engine ENG through the first clutch CL1 and selectively receives torque transmitted from the engine ENG and the second input shaft 4 is connected with the engine ENG through the second clutch CL2 and selective receives torque transmitted from the engine ENG.

The electric supplementary drive unit is a motor/generator 6 that performs functions of both of a motor and a generator, as in common electric vehicles.

The motor/generator 6 is usually composed of a rotor 8 and a stator 10, in which the rotor 8 is directly connected with the second input shaft 4 and the stator 10 is fixed to a housing H.

The torque converting unit is a planetary gear set PG and a single pinion planetary gear set with three rotating elements is used in the first exemplary embodiment of the present invention.

The three rotating elements are a first rotating element N1 that is a sun gear S, a second rotating element N2 that is a planetary carrier PC, and a third rotating element N3 that is a ring gear R.

The first rotating element N1 is directly connected with the second rotary shaft 4 and selectively receives torque transmitted from the engine ENG, or receives torque from the rotor 6 or, in contrast, transmits torque to the rotor 6.

The second rotating element N2 is directly connected with the first input shaft 2 and selectively receives torque from the engine ENG, or reduces torque inputted from the second input shaft 4 and transmits it to the first input shaft 2.

The third rotating element N3 is directly connected to the housing H and keeps operating as a fixing element.

The shifting unit includes first and second input gears G1 and G2 disposed at predetermined intervals from the rear portion of the first input shaft 2, and first and second shift output mechanisms OUT1 and OUT2 disposed in parallel at predetermined intervals from the first input shaft 2.

The first shift output mechanism OUT1 includes a first output shaft 12 disposed in parallel with the first input shaft 2 at a predetermined distance and a first synchronizer SL1 that is a synchronizing unit including first and second shift gears D1 and D2, disposed on the first output shaft 12, and selectively connecting the first shift gear D1 or the second shift gear D2 in synchronization to the first output shaft 12.

The first shift gear D1 is in mesh with the first input gear G1 and the second shift gear D2 is in mesh with the second input gear G2.

The torque changed through the first shift output mechanism OUT1 is transmitted to a differential DIFF, which is well known in the art, through a first output gear 14 on the front end or the rear end of the first output shaft 12.

The second shift output mechanism OUT2 includes a second output shaft 16 disposed in parallel with the first input shaft 2 at a predetermined distance and a second synchronizer SL2 that is a synchronizing unit including third and fourth shift gears D3 and D4, disposed on the second output shaft 16, and selectively connecting the third shift gear D3 or the fourth shift gear D4 to the second output shaft 16.

The third shift gear D3 is in mesh with the first input gear G1 and the fourth shift gear D4 is in mesh with the second input gear G2.

The torque shifted through the second shift output mechanism OUT2 is transmitted to the differential DIFF, which is well known in the art, through a second output gear 18 on the front end or the rear end of the second output shaft 16.

Since the first and second synchronizers SL1 and SL2 are well known in the art, the configuration is not described in detail herein, and the sleeves SLE1 and SLE2 that are used for the first and second synchronizers SL1 and SL2, respectively, has an actuator, as well known in the art, and the actuators are controlled by a transmission control unit.

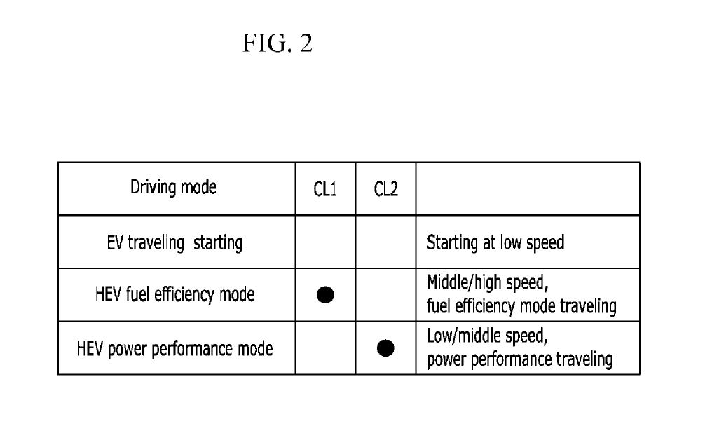

FIG. 2 is table showing operation factors of the power transmission apparatus according to the first exemplary embodiment of the present invention.

Referring to FIG. 2, both of the first and second clutches CL1 and CL2 are not operated in the EV mode, the first clutch CL1 operates in the HEV fuel efficiency mode, the second clutch CL2 operates in the HEV power performance mode, the sleeves SLE1 and SLE of the first and second synchronizers SL1 and SL2 are simultaneously engaged with the shift gears of corresponding stages, thereby shifting.

[EV Mode]

In the EV mode, both of the first and second clutches CL1 and CL2 are not operated and the vehicle is driven by the driving force of the motor/generator 6.

That is, with the third rotating element N3 of the torque converting unit operating as a fixing element, when the driving force of the motor/generator 6 is inputted to the first rotating element N1, the driving force is reduced and outputted through the second rotating element N2 that is an output element, and then transmitted to the first input shaft 2.

As described above, the torque transmitted to the first input shaft 2 is shifted to the stage suitable for traveling in the shifting unit, outputted through the first output gear 14 or the second output gear 18, and transmitted to driving wheels through a final reduction gear FD and the differential DIFF.

As described above, the power transmission apparatus for a vehicle according to the first exemplary embodiment of the present invention, it is possible to shift to the fourth stage in the EV mode, such that it is possible to start smoothly at low speed.

[HEV Fuel Efficiency Mode]

The operation of the first clutch CL1 is controlled in the HEV fuel efficiency mode.

Then, the torque from the engine ENG is transmitted to the first input shaft 2 and they are directly connected, such that the torque transmitted to the first input shaft 2 is shifted to the stage suitable for traveling in the shifting unit, outputted through the first output gear 14 or the second output gear 18, and transmitted to driving wheels through the final reduction gear FD and the differential DIFF.

Accordingly, it is possible to drive in a middle/high range in the HEV fuel efficiency mode and torque increases when auxiliary power is supported from the motor/generator 6, such that it is possible to drive in a high speed region with a high efficiency point and improve fuel efficiency.

In the shifting, shifting is performed after sensing the output speed and synchronizing the gear to shift through the motor/generator 6 and the speed of the output shaft.

[HEV Power Performance Mode]

The operation of the second clutch CL2 is controlled in the HEV power performance mode.

Then, the torque from the engine ENG is transmitted to the second input shaft 4, reduced through the torque converting unit, and then transmitted to the first input shaft 2, such that the torque transmitted to the first input shaft 2 is shifted to the stage suitable for traveling in the shifting unit, outputted through the first output gear 14 or the second output gear 18, and transmitted to driving wheels through the final reduction gear FD and the differential DIFF.

Therefore, power performance operation is possible in a low/middle speed range and torque increases when auxiliary power is supported from the motor generator 6, such that it is possible to drive with a high efficiency point.

In the shifting, shifting is performed after sensing the output speed and synchronizing the gear to shift through the motor/generator 6 and the speed of the output shaft.

As described above, according to the first exemplary embodiment of the present invention, starting and shifting is made by the motor/generator 6 that is an electric supplement drive unit and the planetary gear set PG that is a torque converting unit, such that smooth starting and shifting can be achieved.

Further, it is possible to improve the problem of non-load gear noise and a loss of drag of idle gears which are generated due to the structure in the existing manual transmissions.

Further, the planetary gear set that is used as a torque converting unit distributes input torque in comparison to an external gear, such that transmission efficiency and durability are high and the rigidity is high, and thus it is advantageous in gear whine noise.

Further, when auxiliary power is inputted by the motor/generator, the power is transmitted with torque increased through the planetary gear set and the rotation speed is larger than the engine, such that it can be used in a high speed region with a high efficiency point.

Further, it is possible to start the engine with the motor/generator without a specific start motor and it is possible to shift to the fourth stage in the EV mode, such that it is possible to decrease use at the efficiency point and the capacity of the motor/generator.

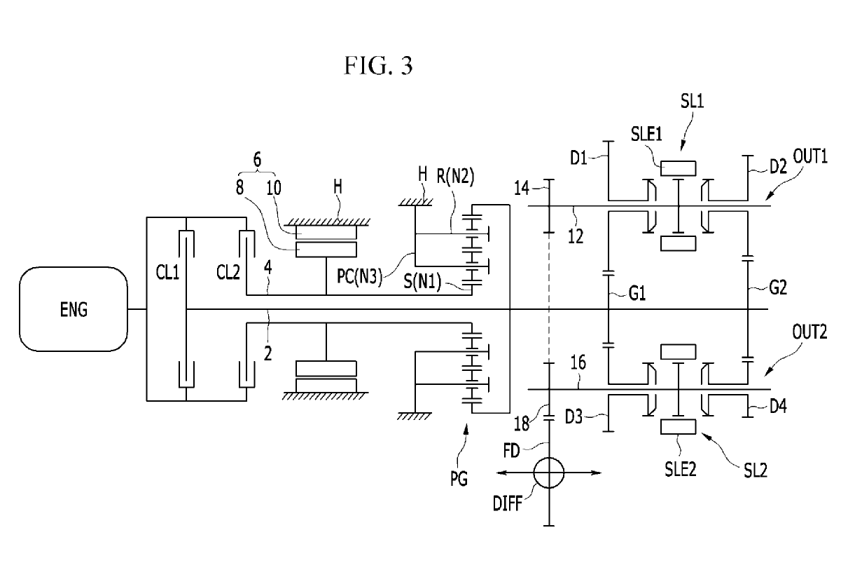

FIG. 3 is a schematic view of a power transmission apparatus for a vehicle according to a second exemplary embodiment of the present invention.

Referring to FIG. 3, in the power transmission apparatus for a vehicle according to the second exemplary embodiment of the present invention, a double pinion planetary gear set is used as a torque converting unit.

Accordingly, in the torque converting unit, the first rotating element N1 is a sun gear S, the second rotating element N2 is a ring gear R, and the third rotating element N3 is a planetary carrier PC.

Accordingly, as compared with the first exemplary embodiment, only the components of the second and third rotating elements N2 and N3 are different and the operational effect is the same, such that the detailed description is not provided.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A power transmission apparatus for a vehicle, comprising:
a power connecting unit including a first clutch and a second clutch;
an input unit including:
a first input shaft selectively connected with an engine through the first clutch; and
a second input shaft disposed coaxially with the first input shaft and selectively connected with the engine through the second clutch;
an electric supplement drive unit that is a motor generator performing functions of both of a motor and a generator and transmits a driving force to the second rotary shaft;
a torque converting unit that is a planetary gear set including first, second, and third rotating elements,
wherein the first rotating element is connected with the electric supplement drive unit through the second rotary shaft,
wherein the second rotating element is selectively connected with the engine through the first rotary shaft, and
wherein the third rotating element functions as a fixing element; and
a shifting unit that shifts and outputs torque of the first input shaft of the input unit at several stages.

2. The apparatus of claim 1, wherein, in the input unit, the second input shaft is a hollow shaft and the first input shaft is coaxially disposed through the second input shaft.

3. The apparatus of claim 1, wherein the electric supplement drive unit includes a rotor connected with the second rotary shaft and a stator disposed around the rotor and fixed to a housing.

4. The apparatus of claim 1, wherein the torque converting unit is a single pinion planetary gear set including:
the first rotating element that is a sun gear of the single pinion planetary gear set;
the second rotating element that is a planetary carrier of the single pinion planetary gear set; and
the third rotating element that is a ring gear of the single pinion planetary gear set.

5. The apparatus of claim 1, wherein the torque converting unit is a double pinion planetary gear set including:
the first rotating element that is a sun gear of the double pinion planetary gear set;
the second rotating element that is a ring gear of the double pinion planetary gear set; and
the third rotating element that is a planetary carrier of the double pinion planetary gear set.

6. The apparatus of claim 1, wherein the shifting unit includes:
first and second input gears disposed on the first input shaft;
first and second output shafts disposed in parallel with the first input shaft; and
a plurality of output gears disposed on the first and second output shafts in mesh with the first or second input gear on the first input shaft and selectively synchronized with the first output shaft or the second output shaft by corresponding synchronizing units.

7. A power transmission apparatus for a vehicle, comprising:
a power connecting unit including a first clutch and a second clutch;
an input unit including:
a first input shaft selectively connected with an engine through the first clutch; and
a second input shaft disposed coaxially with the first input shaft and selectively connected with the engine through the second clutch;
an electric supplement drive unit that is a motor generator performing functions of both of a motor and a generator and transmits a driving force to the second rotary shaft;
a torque converting unit that is a single pinion planetary gear set,
wherein a sun gear of the single pinion planetary gear set that is a first rotating element is connected with the electric supplement drive unit through the second rotary shaft;
wherein a planetary carrier of the single pinion planetary gear set that is a second rotating element is selectively connected with the engine through the first rotary shaft, and
wherein a ring gear of the single pinion planetary gear set that is a third rotating element functions as a fixing element; and
a shifting unit that shifts and outputs torque of the first input shaft of the input unit at several stages.

8. The apparatus of claim 7, wherein, in the input unit, the second input shaft is a hollow shaft and the first input shaft is coaxially disposed through the second input shaft.

9. The apparatus of claim 7, wherein the electric supplement drive unit includes a rotor connected with the second rotary shaft and a stator disposed around the rotor and fixed to a housing.

10. The apparatus of claim 7,
wherein the torque converting unit is a double pinion planetary gear set, and
wherein the first rotating element is a sun gear of the double pinion planetary gear set,
wherein the second rotating element is a ring gear of the double pinion planetary gear set, and
wherein the third rotating element is a planetary carrier of the double pinion planetary gear set.

11. The apparatus of claim 7, wherein the shifting unit includes:
first and second input gears disposed on the first input shaft;
first and second output shafts disposed in parallel with the first input shaft; and
four output gears for shift stages disposed on the first and second output shafts in mesh with the first or second input gear on the first input shaft and selectively synchronized with the first output shaft or the second output shaft by corresponding synchronizing units.

12. A power transmission apparatus for a vehicle, comprising:
a power connecting unit including a first clutch and a second clutch;
an input unit including:
a first input shaft selectively connected with an engine through the first clutch; and
a second input shaft disposed coaxially with the first input shaft and selectively connected with the engine through the second clutch;
an electric supplement drive unit that is a motor generator performing functions of both of a motor and a generator and transmits a driving force to the second rotary shaft;
a torque converting unit that is a double pinion planetary gear set,
wherein a sun gear that is a first rotating element is connected with the electric supplement drive unit through the second rotary shaft,
wherein a ring gear that is a second rotating element is selectively connected with the engine through the first rotary shaft, and
wherein a planetary carrier that is a third rotating element functions as a fixing element; and
a shifting unit that shifts and outputs torque of the first input shaft of the input unit at several stages.

13. The power transmission apparatus of claim 12, wherein, in the input unit, the second input shaft is a hollow shaft and the first input shaft is coaxially disposed through the second input shaft.

14. The apparatus of claim 12, wherein the electric supplement drive unit includes a rotor connected with the second rotary shaft and a stator disposed around the rotor and fixed to a housing.

15. The apparatus of claim 12,
wherein the torque converting unit is a single pinion planetary gear set, and
wherein the first rotating element is a sun gear of the single pinion planetary gear set,
wherein the second rotating element is a planetary carrier of the single pinion planetary gear set, and
wherein the third rotating element is a ring gear of the single pinion planetary gear set.

16. The apparatus of claim 12, wherein the shifting unit includes:
first and second input gears disposed on the first input shaft;
first and second output shafts disposed in parallel with the first input shaft; and
four output gears for shift stages disposed on the first and second output shafts in mesh with the first or second input gear on the first input shaft and selectively synchronized with the first output shaft or the second output shaft by corresponding synchronizing units.

17. A power transmission apparatus for a vehicle, comprising:
a power connecting unit including a first clutch and a second clutch;
an input unit including:
a first input shaft selectively connected with an engine through the first clutch; and
a second input shaft that is a hollow shaft, disposed around the first input shaft without interference, and selectively connected with the engine through the second clutch;
a motor/generator including a rotor connected to the second input shaft and performing functions of both of a motor and a generator;
a torque converting unit that is a single pinion planetary gear set,
wherein a sun gear is connected with the motor/generator through the second rotary shaft,
wherein a planetary carrier is selectively connected with the engine through the first rotary shaft, and
wherein a ring gear functions as a fixing element; and
a shifting unit including:
first and second input gears disposed on the first input shaft;
first and second output shafts disposed in parallel with the first input shaft; and
first, second, third, and fourth output gears disposed on the first and second output shafts in mesh with the first or second input gear on the first input shaft and selectively synchronized with the first output shaft or the second output shaft by corresponding synchronizing units.

18. The apparatus of claim 17, wherein, in the shifting unit, the first shift gear on the first output shaft and the third shift gear on the second output shaft are externally engaged with the first input gear, and the second shift gear on the first output shaft and the fourth shift gear on the second output shaft are externally engaged with the second input gear.

19. A power transmission apparatus for a vehicle, comprising:
a power connecting unit including a first clutch and a second clutch;
an input unit including:
a first input shaft selectively connected with an engine through the first clutch; and
a second input shaft that is a hollow shaft, disposed around the first input shaft without interference, and selectively connected with the engine through the second clutch;
a motor/generator including a rotor connected to the second input shaft and performing functions of both of a motor and a generator;
a torque converting unit that is a double pinion planetary gear set,
wherein a sun gear of the double pinion planetary gear set is connected with the motor/generator through the second rotary shaft,
wherein a ring gear of the double pinion planetary gear set is selectively connected with the engine through the first rotary shaft, and
wherein a planetary carrier of the double pinion planetary gear set functions as a fixing element; and
a shifting unit including:
first and second input gears disposed on the first input shaft;
first and second output shafts disposed in parallel with the first input shaft; and
first, second, third, and fourth output gears disposed on the first and second output shafts in mesh with the first or second input gear on the first input shaft and selectively synchronized with the first output shaft or the second output shaft by corresponding synchronizing units.

20. The apparatus of claim 19, wherein, in the shifting unit, the first shift gear on the first output shaft and the third shift gear on the second output shaft are externally engaged with the first input gear, and the second shift gear on the first output shaft and the fourth shift gear on the second output shaft are externally engaged with the second input gear.
